(19) United States
(12) Patent Application Publication
(10) Pub. No.: US 2026/0295744 A1
(43) Pub. Date: Oct. 1, 2026

(54) WORKPIECE FRAMES WITH LOCATOR FEATURES FOR MACHINE FIXTURES

(71) Applicant: Rolls-Royce Corporation, Indianapolis, IN (US)

(72) Inventors: Rusty Garner, Indianapolis, IN (US); Monica Munoz, Indianapolis, IN (US); Damon Ward, Indianapolis, IN (US)

(21) Appl. No.: 19/092,586

(22) Filed: Mar. 27, 2025

(51) Int. Cl. B23Q 3/06; B23Q 3/18

(52) U.S. Cl. CPC B23Q 3/065; B23Q 3/186

(57) ABSTRACT

A machine tool system includes a workpiece, a machine configured to modify the workpiece and including a tool base, and a workpiece frame. The workpiece frame is repositionable on and couplable to the tool base to support the workpiece relative to the machine, the tool base including a first wall configured to support the workpiece frame, the workpiece frame including a first arm configured to be generally aligned with the first wall of the tool base when the workpiece frame is coupled to tool base. The workpiece frame includes a first locator component arranged on the first arm and the tool base includes a second locator component arranged on the first wall and configured to engage the first locator component. The engagement of the first and second locator components locates the workpiece frame on the tool base in a desired position relative to the tool base.

### FIELD OF THE DISCLOSURE

The present disclosure relates generally to machine tool systems, and more specifically to workpiece supports of machine tool systems.

### BACKGROUND

Electrochemical machining (ECM) is a non-contact, non-thermal material removal process capable of small features, high quality surfaces, and high repeatability for production parts. Pulsed electrochemical machining (PECM), sometimes called precision electrochemical machining, is a more precise variant of ECM that uses a pulsed power supply.

Unlike many other manufacturing processes, there is no contact between the machining component or tool bit, which may be referred to as a cathode, and the workpiece in PECM. Material of the workpiece in close proximity to the machining component is dissolved by an electrochemical process, and the by-products are flushed away with a flowing electrolyte. The resulting workpiece has the shape that is an inverse of the machining component.

PECM provides some advantages over other manufacturing processes. For example, PECM may be used for relatively hard materials that may be difficult to machine using conventional methods. As another example, PECM can be used to machine small, intricate, or complex shapes or contours with a relatively high surface quality. Some workpieces may be easily distorted or non-repositionable and, thus, difficult to reposition during PECM.

### SUMMARY

The present disclosure may comprise one or more of the following features and combinations thereof.

According to a first aspect of the present disclosure, a machine tool system includes a thin-walled three-dimensional workpiece and a machine configured to modify the thin-walled three-dimensional workpiece, the machine including a tool base configured to at least partially support the thin-walled three-dimensional workpiece and a shaft spaced apart from the tool base along a first axis and configured to move along the first axis relative to the tool base to modify the thin-walled three-dimensional workpiece. The machine tool system further includes a workpiece frame that is repositionable on and couplable to the tool base to support the thin-walled three-dimensional workpiece relative to the first axis during modification of the thin-walled three-dimensional workpiece, the tool base including a first wall configured to support at least a portion of the workpiece frame, the workpiece frame including a first arm configured to be generally aligned with the first wall of the tool base when the workpiece frame is coupled to tool base.

In some embodiments, the workpiece frame includes a first locator component arranged on the first arm and the tool base includes a second locator component arranged on the first wall and configured to engage the first locator component of the workpiece frame when the workpiece frame is arranged on the tool base prior to coupling of the workpiece frame to the tool base, and the engagement of the first and second locator components locates the workpiece frame on the tool base in a first desired position relative to the tool base such that the workpiece frame is configured to be coupled to the tool base in the first desired position.

In some embodiments, the first wall of the tool base includes a side surface that faces a first direction, and the second locator component includes a first locator block removably coupled to the side surface of the tool base, the first locator block being configured to engage the first locator component of the workpiece frame when the workpiece frame is arranged on the tool base.

In some embodiments, the first arm of workpiece frame includes a side surface facing the first direction, the first locator component being arranged on the side surface, the first locator block includes a lower portion removably coupled to the side surface of the tool base and an upper portion above the lower portion, and the upper portion includes a first locator pin that engages the first locator component when the workpiece frame is arranged on the tool base so as to locate the workpiece frame relative to the tool base.

In some embodiments, the lower portion of the first locator block includes a lower surface that contacts the side surface of the first wall of the tool base when the first locator block is removably coupled to the first wall, the lower surface defining a first plane, the upper portion of the first locator block includes an upper surface defining a second plane, the upper portion includes an upper hole formed therein within which the first locator pin is arranged, the first locator component is a second locator pin arranged in a hole in the first arm of the workpiece frame, and a forward surface of the first locator pin contacts and engages the second locator pin when the workpiece frame is arranged on the tool base so as to locate the workpiece frame relative to the tool base.

In some embodiments, in a first configuration of the first locator block, the second plane defined by the upper surface of the first locator block is offset from the first plane defined by the lower surface a first distance in the first direction such that the second plane is further from the first wall of the tool base than the first plane when the first locator block is removably coupled to the first wall, and, in a second configuration of the first locator block, the second plane is offset from the first plane a second distance in the first direction less than the first distance.

In some embodiments, the lower surface of the first locator block is machinable such that material can be removed from the lower surface such that, prior to machining the lower surface, the first locator block is in the first configuration, and, after machining the lower surface to remove material therefrom, the first locator block is in the second configuration.

In some embodiments, in the first configuration, the first locator pin of the first locator block contacts the second locator pin of the workpiece frame so as to locate the workpiece frame in the first desired position relative to the tool base, and, in the second configuration, the first locator pin of the first locator block contacts the second locator pin of the workpiece frame so as to locate the workpiece frame in a second desired position relative to the tool base different than the first desired position.

In some embodiments, the workpiece frame includes a second arm extending from a terminal end of the first arm, the tool base includes a second wall extending from a terminal end of the first wall, and a second locator block is removable coupled to the second wall and configured to engage a third locator component of the workpiece frame when the workpiece frame is arranged on the tool base.

In some embodiments, the first locator component includes a first locator sleeve arranged on the first arm of the workpiece frame and the second locator component includes a first locator pin arranged on the first wall of the tool base, and the first locator sleeve receives the first locator pin therein when the workpiece frame is arranged on the tool base so as to locate the workpiece frame relative to the tool base in a first desired position.

In some embodiments, the first arm of the workpiece frame includes a first hole formed therein that opens toward the first wall of the tool base when the workpiece frame is arranged on the tool base, the first wall includes a second hole formed therein that opens toward the first hole when the workpiece frame is arranged on the tool base, and the first locator sleeve is arranged in the first hole and the first locator pin is arranged in the second hole and protrudes therefrom.

In some embodiments, the machine tool system further includes a second locator sleeve shaped differently than the first locator sleeve and a second locator pin shaped differently than the first locator pin. In some embodiments, the second locator sleeve and pin can be inserted into the first and second holes instead of the first locator sleeve and pin so as to locate the workpiece frame relative to the tool base in a second desired position different than the first desired position.

In some embodiments, the first and second holes each include a plurality of annular barbed recesses formed therein, the first locator sleeve and the first locator pin each include a plurality of annular barbed protrusions extending from outer surfaces of the first locator sleeve and the first locator pin, and the plurality of annular barbed protrusions fit within the plurality of annular barbed recesses of the first and second holes so as to secure the first locator sleeve and the first locator pin within the first and second holes.

In some embodiments, the first and second holes each include a plurality of annular recesses formed therein, the first locator sleeve and the first locator pin each include a plurality of annular ribs extending from outer surfaces of the first locator sleeve and the first locator pin, and the plurality of annular ribs fit within the plurality of annular recesses of the first and second holes so as to secure the first locator sleeve and the first locator pin within the first and second holes.

According to a further aspect of the present disclosure, a machine tool system includes a workpiece, a machine configured to modify the workpiece, the machine including a tool base configured to at least partially support the workpiece, and a workpiece frame that is repositionable on and couplable to the tool base to support the workpiece. In some embodiments, the workpiece frame includes a first locator component and the tool base includes a second locator component arranged on the tool base and configured to engage the first locator component of the workpiece frame when the workpiece frame is arranged on the tool base prior to coupling of the workpiece frame to the tool base, the first and second locator components are configurable in a first configuration and a second configuration, in the first configuration, the engagement of the first and second locator components locates the workpiece frame on the tool base in a first desired position relative to the tool base such that the workpiece frame is configured to be coupled to the tool base in the first desired position, and, in the second configuration, the second locator component engages the first locator component so as to locate the workpiece frame on the tool base in a second desired position relative to the tool base different than the first desired position.

In some embodiments, the tool base includes a side surface, and the second locator component includes a first locator block removably coupled to the side surface of the tool base, the first locator block being configured to engage the first locator component of the workpiece frame when the workpiece frame is arranged on the tool base, the workpiece frame includes a side surface, the first locator component being arranged on the side surface, the first locator block includes a lower portion removably coupled to the side surface of the tool base and an upper portion above the lower portion, and the upper portion includes a first locator pin that engages the first locator component when the workpiece frame is arranged on the tool base so as to locate the workpiece frame relative to the tool base.

In some embodiments, the lower portion of the first locator block includes a lower surface that contacts the side surface the tool base when the first locator block is removably coupled to the side surface of the tool base, the lower surface defining a first plane, the upper portion of the first locator block includes an upper surface defining a second plane, in the first configuration, the second plane defined by the upper surface of the first locator block is offset from the first plane defined by the lower surface a first distance in the first direction such that the second plane is further from the tool base than the first plane when the first locator block is removably coupled to the tool base, in the second configuration, the second plane is offset from the first plane a second distance in the first direction less than the first distance, and the lower surface of the first locator block is machinable such that material can be removed from the lower surface such that, prior to machining the lower surface, the first locator block and the first locator component are in the first configuration, and, after machining the lower surface to remove material therefrom, the first locator block and the first locator component are in the second configuration.

In some embodiments, the first locator component includes a first locator sleeve arranged on a first arm of the workpiece frame and the second locator component includes a first locator pin arranged on a first wall of the tool base, in the first configuration of the first locator component and the second locator component, the first locator sleeve receives the first locator pin therein when the workpiece frame is arranged on the tool base so as to locate the workpiece frame relative to the tool base in the first desired position, the machine tool system further includes a second locator sleeve shaped differently than the first locator sleeve and a second locator pin shaped differently than the first locator pin, the second locator sleeve corresponds to the second configuration of the first locator component and the second locator pin corresponds to the second configuration of the second locator component, and, in the second configuration of the first locator component and the second locator component, the second locator sleeve and pin are arranged on the workpiece frame and the tool base instead of the first locator sleeve and pin such that the second locator sleeve receives the second locator pin therein when the workpiece frame is arranged on the tool base so as to locate the workpiece frame relative to the tool base in the second desired position.

According to a further aspect of the present disclosure, a method includes providing a machine configured to modify a workpiece, the machine including a tool base, providing a workpiece frame that is repositionable on and couplable to the tool base to support the workpiece, arranging the workpiece in the workpiece frame, and arranging the workpiece frame on the tool base, the workpiece frame includes a first locator component and the tool base includes a second locator component removably arranged on the tool base and configured to engage the first locator component of the workpiece frame when the workpiece frame is arranged on the tool base prior to coupling of the workpiece frame to the tool base, the first and second locator components are configurable in a first configuration and a second configuration, in the first configuration, the engagement of the first and second locator components locates the workpiece frame on the tool base in a first desired position relative to the tool base such that the workpiece frame is configured to be coupled to the tool base in the first desired position.

In some embodiments, the method further includes determining a second desired position of the workpiece frame relative to the tool base different from the first desired position, removing at least one of the first and second locator components from at least one of the workpiece frame or the tool base, and coupling the removed at least one of the first and second locator components to the at least one of the workpiece frame and the tool base in the second configuration of the at least one of the first and second locator components such that the second locator component engages the first locator component so as to locate the workpiece frame on the tool base in a second desired position relative to the tool base different than the first desired position.

In some embodiments, the tool base includes a first wall having a side surface that faces a first direction, the workpiece frame includes a first arm having a side surface that faces the first direction, the second locator component includes a first locator block removably coupled to the side surface of the tool base, the first locator block being configured to engage the first locator component of the workpiece frame when the workpiece frame is arranged on the tool base, and the first locator block includes an upper surface having a first locator pin configured to engage the first locator component of the workpiece frame and a lower surface that is machinable such that material can be removed from the lower surface such that, prior to machining the lower surface, the first locator block and the first locator component are in the first configuration, and, after machining the lower surface to remove material therefrom, the first locator block and the first locator component are in the second configuration.

In some embodiments, the arranging of the workpiece frame on the tool base causes the first locator pin of the first locator block to contact the first locator component of the workpiece frame such that the side surface of the first arm of the workpiece frame is generally aligned with the side surface of the first wall of the tool base, and the coupling of the removed at least one of the first and second locator components includes coupling the first locator block to the side surface of the first wall of the tool base in the second configuration so as to cause the first locator block to contact the first locator component of the workpiece frame such that the side surface of the first arm of the workpiece frame is offset from the side surface of the first wall of the tool base in a direction away from the first locator block.

These and other features of the present disclosure will become more apparent from the following description of the illustrative embodiments.

### BRIEF DESCRIPTION OF THE DRAWINGS

FIG. 1 is a diagrammatic view of a machine tool system of the present disclosure, showing that the machine tool system includes a workpiece frame removably coupled to a tool base of a machine in a first position, the workpiece frame supports a workpiece thereon;

FIG. 2 is a diagrammatic view of the machine tool system of FIG. 1, showing the workpiece frame removably coupled to the tool base of the machine in a second position, the workpiece frame supports the workpiece, the workpiece frame allowing for movement of the workpiece between the first and second positions without requiring removal of the workpiece from the workpiece frame;

FIG. 3 is a perspective view of the workpiece frame and the tool base of FIG. 1, showing that the workpiece frame can arranged on a top side of the tool base, and showing that the tool base can include a plurality of locator blocks that contact corresponding locator components on the workpiece frame that locate the workpiece frame on the tool base in a first desired position relative to the tool base such that the workpiece frame is configured to be coupled to the tool base in the first desired position;

FIG. 4A is a magnified view of a locator component of the workpiece frame of FIG. 3;

FIG. 4B is a rear perspective view of a locator block of the tool base of FIG. 3, showing that the locator block includes a lower portion having a fastener extending therethrough and an upper portion having a locator pin arranged therein, a surface of the lower surface facing away from the locator block being machinable such that material can be removed from the surface;

FIG. 4C is a front perspective view of the locator block of FIG. 4B, showing the fastener extending through the lower portion and a terminal end of the locator pin arranged in a hole formed in the upper portion of the locator block;

FIG. 5A is a side cross-sectional view of a portion of the workpiece frame and the tool base of FIG. 3 at which the locator block engages, showing the locator block spaced apart from the workpiece frame and the tool base;

FIG. 5B is a side cross-sectional view of a portion of the workpiece frame and the tool base of FIG. 3 at which the locator block engages, showing the locator block engaged with the workpiece frame and the tool base so as to locate the workpiece frame at a first desired position relative to the tool base;

FIG. 5C is a side cross-sectional view of a portion of the workpiece frame and the tool base of FIG. 3 at which the locator block engages, showing the locator block after the lower surface has been machined and material removed therefrom, resulting in the located block engaging with the workpiece frame and the tool base so as to locate the workpiece frame at a second desired position relative to the tool base different than the first desired location, the second desired position being a position in which a side surface of the workpiece frame is offset slightly from a side surface of the tool base;

FIG. 6 is a perspective view of a machine tool system according to a further aspect of the present disclosure, showing that a workpiece frame arranged on a top side of a tool base, and showing that the workpiece frame includes a first locator component arranged in a hole formed in an arm of the workpiece frame and the tool base includes a second locator component arranged in a hole formed in a wall of the tool base aligned with the hole of the workpiece frame;

FIG. 7 is a perspective view of the tool base of FIG. 6, showing the hole formed in the wall of the tool base;

FIG. 8A is a side view of the second locator component of FIG. 6, showing that the second locator component is a locator pin arranged in the hole in the wall of the tool base, and showing that the outer surface of the pin includes plurality of annular barbed protrusions;

FIG. 8B is a top perspective view of the locator pin of FIG. 8A;

FIG. 9A is a side view of the first locator component of FIG. 6, showing that the first locator component is a locator sleeve that is arranged in the hole in the arm of the workpiece frame, and showing that the outer surface of the sleeve includes plurality of annular barbed protrusions;

FIG. 9B is a top perspective view of the locator sleeve of FIG. 9A;

FIG. 9C is a top perspective view of a locator sleeve similar to the locator pin of FIG. 9A, but in a second configuration in which the central cavity is slightly offset from center;

FIG. 10A is a bottom perspective view of the locator sleeve of FIG. 9A arranged in the hole of the arm of the workpiece frame;

FIG. 10B is a top perspective view of the locator pin of FIG. 8A arranged in the hole of the wall of the tool base;

FIG. 11A is a side cross-sectional view of the holes formed in the workpiece frame and the tool base of FIG. 6, showing that the holes include a plurality of annular barbed recesses formed therein via deformation caused by the barbed protrusions of the sleeve and the pin;

FIG. 11B is a side cross-sectional view of the locator sleeve and the locator pin of FIG. 6, showing that a tapered pin head of the locator pin is arranged in the locator sleeve having a corresponding taper when the workpiece frame is arranged on the tool base, and showing that the annular barbed protrusions of the locator sleeve and the locator pin can engage the annular barbed recesses of the holes of the workpiece frame and the tool base;

FIG. 12A is a side view of an alternative second locator component similar to the locator component of FIG. 8A, showing that the second locator component is a locator pin that is arranged in the hole in the wall of the tool base, and showing that the outer surface of the pin includes plurality of annular ribs;

FIG. 12B is a top perspective view of the locator pin of FIG. 12A;

FIG. 12C is a top perspective view of a locator pin similar to the locator pin of FIG. 12A, but in a second configuration in which the pin head is slightly offset from center;

FIG. 13A is a side view of an alternative second locator component similar to the locator component of FIG. 9A, showing that the first locator component is a locator sleeve that is arranged in the hole in the arm of the workpiece frame, and showing that the outer surface of the sleeve includes plurality of annular ribs;

FIG. 13B is a top perspective view of the locator sleeve of FIG. 13A;

FIG. 14A is a bottom perspective view of the locator sleeve of FIG. 13A arranged in the hole of the arm of the workpiece frame;

FIG. 14B is a top perspective view of the locator pin of FIG. 12A arranged in the hole of the wall of the tool base;

FIG. 15A is a side cross-sectional view of the holes formed in the workpiece frame and the tool base of FIG. 6 configured to receive the locator sleeve and the locator pin of FIGS. 12A and 13A, showing that the holes include a plurality of annular recesses formed therein via deformation caused by the annular protrusions of the sleeve and the pin; and

FIG. 15B is a side cross-sectional view of the locator sleeve and the locator pin of FIGS. 12A and 13A, showing that a tapered pin head of the locator pin is arranged in the locator sleeve having a corresponding taper when the workpiece frame is arranged on the tool base, and showing that the annular ribs of the locator sleeve and the locator pin can engage the annular recesses of the holes of the workpiece frame and the tool base.

### DETAILED DESCRIPTION

For the purposes of promoting an understanding of the principles of the disclosure, reference will now be made to a number of illustrative embodiments illustrated in the drawings and specific language will be used to describe the same.

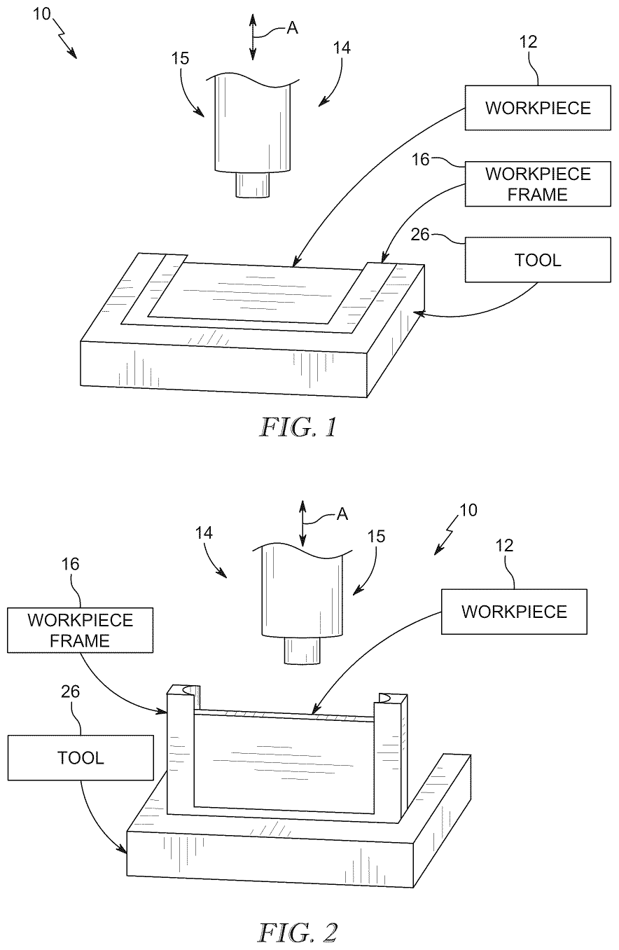

A machine tool system 10 includes a workpiece 12, a machine 14, and a workpiece frame 16, as shown in FIGS. 1 and 2. In illustrative embodiments, the workpiece 12 is a thin-walled three-dimensional workpiece. The machine 14 is configured to modify the workpiece 12. The workpiece frame 16 supports the workpiece 12 and is repositionable and relocatable on the machine 14 in different positions. The workpiece 12 remains stationary relative to the workpiece frame 16 such that repositioning of the workpiece frame 16 on the machine 14 also repositions the workpiece 12 such that different sides of the workpiece 12 may be modified by the machine 14 without requiring removal of the workpiece 12 from the workpiece frame 16.

The machine 14 includes a tool base 26 and a shaft 15, as shown in FIGS. 1 and 2. The tool base 26 supports the workpiece frame 16, and thus, the workpiece 12, relative to the shaft 15. The shaft 15 is spaced apart from the tool base 26 and moves along a first axis A to modify the workpiece 12. The workpiece frame 16 is configured to removably couple with the tool base 26 and is movable between multiple orientations and positions relative to the tool base 26. For example, as shown in FIG. 1, the workpiece frame 16 can be arranged in a first orientation relative to the tool base 26, and, as shown in FIG. 2, the workpiece frame 16 can be arranged in a first orientation relative to the tool base 26. In the illustrative embodiment shown in FIGS. 1 and 2, the second orientation is offset by about 90 degrees compared to the first orientation. In other embodiments, the second orientation is offset by 180 degrees compared to the first orientation. In other embodiments, the second orientation may be offset from the first orientation by any suitable rotation angle and about any suitable axis through the workpiece frame 16. Moreover, as will be described in detail below, the workpiece frame 16 can be repositioned relative to the tool base 26 without being rotated, in particular by modifying the locator blocks 28 that locate the workpiece frame 16 on the tool base 26.

In some embodiments, the machine 14 is capable of pulsed electrochemical machining (PECM). In such an embodiment, the shaft 15 or bit attached to the shaft 15 may be referred to as a cathode. To modify the workpiece 12, the shaft 15 moves toward the workpiece 12 and oscillates along the first axis A, but does not contact the workpiece 12. Once the shaft 15 is adjacent the workpiece 12 to form a gap therebetween, an electrolyte is injected into the gap. The electrolyte acts as an electron transfer medium to facilitate anodic dissolution of the material of the workpiece 12 adjacent the shaft 15. In some embodiments, the electrolyte may be a salt-based solution. The electrolyte allows electrical current to flow between the shaft 15 and the workpiece 12. Any by-products, such as, for example, metal hydroxides or hydrogen gas, of the electrochemical process are then flushed away by the electrolyte. The shaft 15 illustratively has a shape inverse to that of the desired workpiece 12 shape. In some embodiments, the shaft 15 may comprise titanium, stainless steel, copper, or any other suitable current carrying material.

Because PECM is a non-contact and non-thermal process, the workpiece 12 is not subjected to thermal or mechanical stresses. Additionally, because PECM is a non-contact and non-thermal process, the shaft 15 is not typically consumed or worn during the process of machining. In other embodiments, the machine 14 performs other subtractive or additive processes and may contact the workpiece 12. For example, the machine 14 may provide turning, milling, drilling, grinding, cutting, laser cutting, waterjet cutting, electrical discharge machining, plasma cutting, laser deposition, 3D printing, etc.

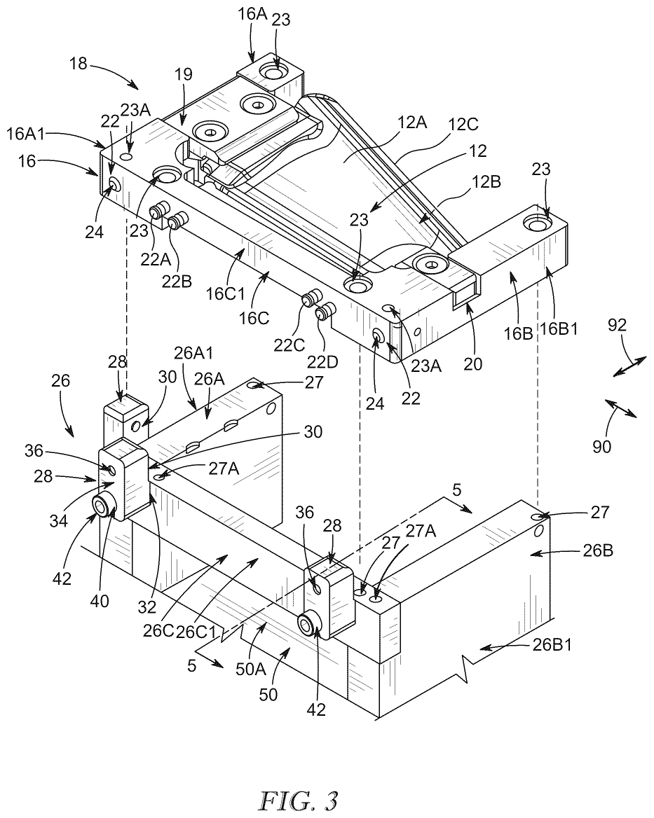

In some embodiments, the machine 14 is a single axis machine 14. In other words, the shaft 15 of the machine 14 only moves along the first axis A. Thus, to modify different sides of the workpiece 12, the workpiece 12 is repositioned such that the different sides may be modified by the shaft 15 moving along the first axis A. Similarly, different areas of the same side of the workpiece 12 may need to be machined, and thus the workpiece 12 may need to be adjusted as it rests on the top side of the tool base 26, as shown in FIG. 3.

The workpiece 12 may be relatively thin and easily distorted or non-repositionable in conventional fixtures and any repositioning of the workpiece 12 itself may distort the workpiece 12. The workpiece frame 16 and the tool base 26 of the present disclosure provides the ability to reposition the workpiece 12 without removal of the workpiece 12 from the workpiece frame 16. In this way, the workpiece frame 16 is repositioned, which also repositions the workpiece 12, while allowing the workpiece 12 to remain stationary relative to the workpiece frame 16.

The workpiece 12 is illustratively a thin-walled three-dimensional workpiece, as shown in FIG. 3. The workpiece 12 includes a first side 12A, a second side 12B opposite the first side 12A, and an edge 12C that extends between and interconnects the first side 12A and the second side 12B. The first side 12A, the second side 12B, and the edge 12C may each be modified by the machine 14 by repositioning the workpiece frame 16. In some embodiments, the workpiece 12 may be used in a gas turbine engine. For example, the workpiece 12 may form a part of a vane or a blade of a gas turbine engine. The workpiece 12 may provide a coversheet for a pressure side and/or a suction side of a vane or a blade.

As shown in FIG. 3, the workpiece frame 16 includes a body 18 and workpiece locators 19, 20. The body 18 is configured to be coupled to the tool base 26 in the different positions. The workpiece locator 19 contacts the workpiece 12 to position the workpiece 12 relative to the body 18. Precise positioning of the workpiece 12 relative to the body 18 and the body 18 relative to the tool base 26 ensures that the workpiece 12 is properly aligned with the shaft 15 in the different positions of the workpiece 12.

In illustrative embodiments, the body 18 is C-shaped, as shown in FIG. 3. The C-shaped body 18 provides open access to the edge 12C of the workpiece 12, as shown in FIGS. 2 and 3. This open access allows the machine 14 to more readily modify the workpiece 12. The C-shaped body 18, thus, provides access to three sides of the workpiece 12, including the first side 12A, the second side 12B, and the edge 12C. In some embodiments, the body 18 may not be C-shaped.

The body 18 includes a first arm 16A, a second arm 16B, and a third arm 16C. The first arm 16A and the second arm 16B are spaced apart from one another, and the third arm 16C extends between and interconnects first terminal ends of the first arm 16A and the second arm 16B. Because the body 18 is C-shaped, second terminal ends of the first arm 16A and the second arm 16B are not interconnected, as shown in FIG. 3.

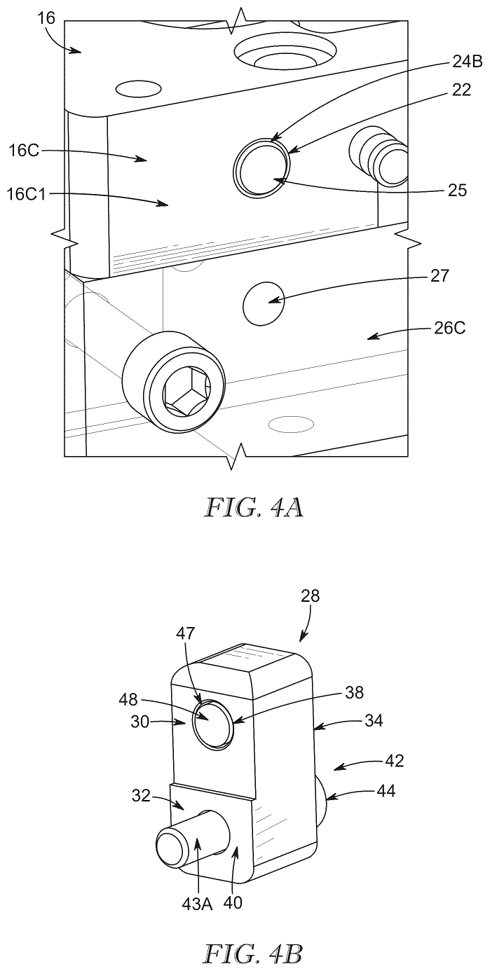

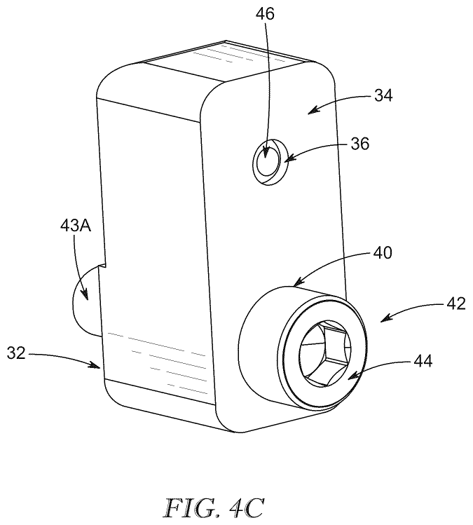

Illustratively, the arms 16A, 16B, 16C each define planar surfaces, as shown in FIGS. 3 and 4A. For example, outwardly-facing side surfaces 16A1, 16B1, 16C1 of each arm 16A, 16B, 16C, as shown in FIG. 3, are substantially planar, as well as the other surface of the arms 16A, 16B, 16C. As will be described in detail below, the planar side surfaces 16A1, 16B1, 16C1 generally align with planar sides surfaces 26A1, 26B1, 26C1 of walls 26A, 26B, 26C of the tool base 26 so as to locate the workpiece frame 16 on the tool base 26.

The workpiece locators 19, 20 can include a first clamp member 19 and a second clamp member 20. The first and second clamps 19, 20 are coupled to the body 18 and extend inwardly (i.e. toward the opposing arm) to couple with the workpiece 12, in particular to clamp on the workpiece 12 and hold the workpiece 12 in position relative to the workpiece frame 16.

In order to accurately couple the workpiece frame 16 to the tool base 26, the workpiece frame 16 includes a plurality of fastener holes 23, a plurality of frame locating pins 24, and a plurality of pins 22A, 22B, 22C, 22D, as shown in FIG. 3. The plurality of fastener holes 23 are used to couple the body 18 to the tool base 26. The plurality of frame locating pins 24 are used to position the body 18 relative to the tool base 26. The plurality of pins 22A, 22B, 22C, 22D are configured to couple to a portion of the machine 14 to the workpiece frame 16. For example, the portion of the machine 14 may be a flow block that couples with the workpiece frame 16 to direct the electrolyte through the gap formed between the workpiece 12 and the shaft 15.

The plurality of fastener holes 23 illustratively includes four holes 23, as shown in FIG. 3, although additional holes or fewer holes are contemplated. Corresponding holes 27 are formed in an upper surface of the walls 26A, 26B, 26C of the tool base 26 so that fasteners can be extended through the holes 23, 27 to secure the workpiece frame 16 to the tool base 26. In some embodiments, the workpiece frame 16 and the tool base 26 can include additional holes 23A, 27A, although in other embodiments, these holes could also be or alternatively be used as locating holes for machines other than the primary machine being utilized, which may be the PECM machine.

The plurality of pins 22A, 22B, 22C, 22D are coupled to and extend outwardly away from the third arm 16C of the body 18, as shown in FIG. 3. illustratively, each of the pins 22A, 22B, 22C, 22D is received in a corresponding hole formed in the body 18. Each of the pins 22A, 22B, 22C, 22D is received in the corresponding hole to extend outwardly beyond the surface 16C1 of the third arm 16C beyond the locator pins 24. The pins 22A, 22B, 22C, 22D are located between two of the locator pins 24 along the third arm 16C.

As previously described, the plurality of pins 22A, 22B, 22C, 22D are configured to couple to a portion of the machine 14 to couple the portion of the machine 14 to the workpiece frame 16. For example, the portion of the machine 14 may be the flow block. The plurality of pins 22A, 22B, 22C, 22D may only be used when the flow block is coupled with the workpiece frame 16.

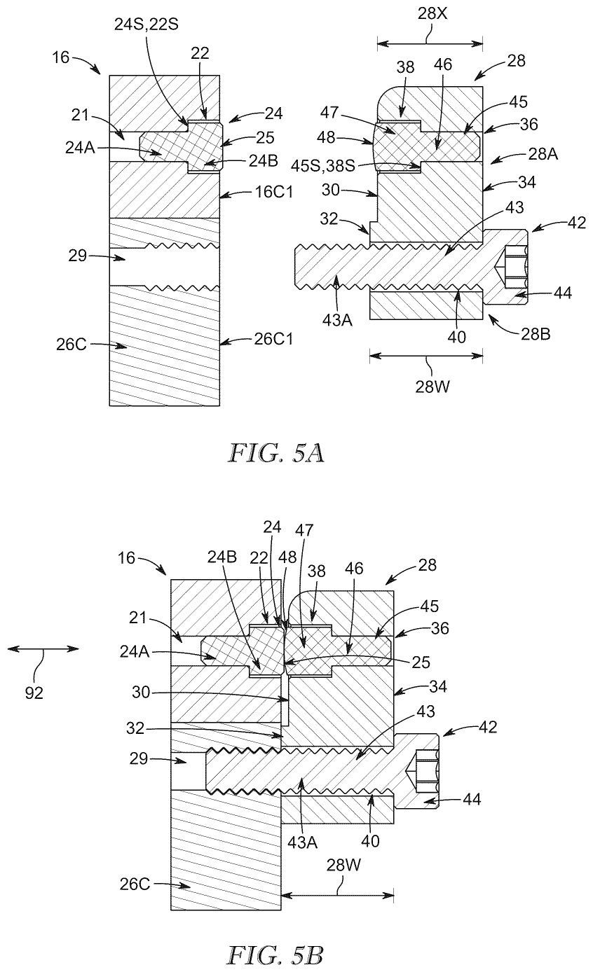

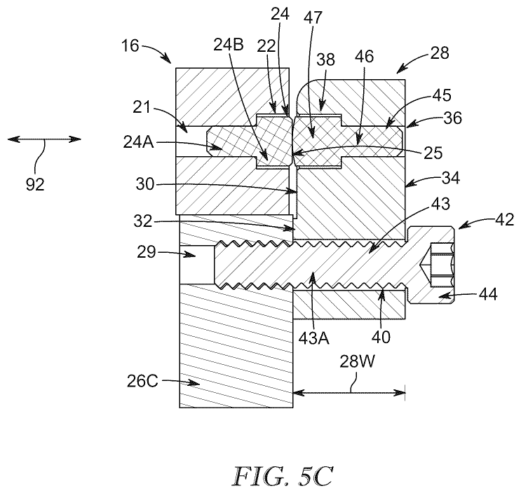

The workpiece frame 16 further includes one or more holes 22 formed in the side surfaces 16A1, 16B1, 16C1 of the arms 16A, 16B, 16C, within which the locator pins 24 are arranged. The locator pins 24, also referred to herein as first locator components, are configured to engage locator pins 45 arranged in the locator blocks 28 so as to locate the workpiece frame 16 relative to the tool base 26. As can be seen in greater detail in FIG. 5A, the locator pins 24 are configured to extend slightly from the side surface of the arm the pin is located in (e.g. side surface 16C1 of the arm 16C, as shown in FIG. 5A).

As can be seen in FIG. 5A, each locator pin 24 includes a main portion 24A and a larger head portion 24B. A smaller hole 21 having a smaller diameter than the hole 22 opens into the hole 22, with the head portion 24B being arranged in the hole 22 and extending into the main portion 24A which is arranged in the smaller hole 21. The step 24S created by the transition of the head portion 24B to the main portion 24A rests on the step 22S created by the transition of the hole 22 to the smaller hole 21 so as to prevent inward movement of the pin 24 when pressed on by the locator pin 45 of the locator block 28. FIG. 4A shows a front perspective view of how the head surface 25 of the head portion 24B (also referred to herein as a forward surface herein) can protrude slightly away from the side surface 16C1 of the arm 16C of the workpiece frame 16.

Referring again to FIG. 3, the tool base 26 includes a similar C-shape as the workpiece frame 16, in particular having a first wall 26A, a second wall 26B spaced apart from the first wall 26A, and a third wall 26C extending between and interconnecting terminal ends of the first and second walls 26A, 26B. A base platform 50 can extend between bottom sides of the first and second walls 26A, 26B. In some embodiments, the third wall 26C may have a smaller height than the first and second walls 26A, 26B such that a gap 50A is formed between a bottom side of the third wall 26C and the base platform 50.

As shown in FIG. 3, the walls 26A, 26B, 26C each define planar surfaces, specifically the outwardly-facing side surfaces 26A1, 26B1, 26C1 that generally align with planar sides surfaces 16A1, 16B1, 16C1 of walls 16A, 16B, 16C of the workpiece frame 16 so as to locate the workpiece frame 16 on the tool base 26. Each wall 16A1, 16B1, 16C1 faces the same direction (referred to herein as the first direction) as the corresponding wall 26A1, 26B1, 26C1. A person skilled in the art will understand that the term “generally” indicates that the surfaces 16A1, 16B1, 16C1 may be perfectly aligned with and coplanar with the surfaces 26A1, 26B1, 26C1, or may be offset from each other by a small factor such that the top surface of the walls 26A, 26B, 26C still support the arms 16A, 16B, 16C of the workpiece frame 16 thereon, and such that the holes 23, 27 are still aligned enough such that fasteners can still be extended therethrough to secure the workpiece frame 16 to the tool base 26.

Each locator block 28, also referred to herein as a second locator component, can be formed identically to one another, and various configurations and numbers of locator blocks 28 can be used on the tool base 26 so as to locate the workpiece frame 16 on the tool base 26. For example, as shown in FIG. 3, three locator blocks 28 may be utilized, with two blocks 28 being arranged on the third wall 26C and one block 28 being arranged on the first wall 26A. A corresponding number of locator pins 24 are provided on the workpiece frame 16 for locating the workpiece frame 16 on the tool base 26.

As can be seen in FIGS. 4B-5C, each locator block 28 can be removably coupled to the tool base 26. Although the following description of the locator block 28 refers to the third wall 26C due to the views shown in FIGS. 5A-5C, a person skilled in the art will understand that the same description applies to locator blocks 28 arranged on any of the walls 26A, 26B, 26C. The locator block 28 is removably coupled to the wall 26C via a fastener 42 that extends into a corresponding hole 29 formed in the wall 26C. The fastener 42 includes a main body 43 and a head 44, the main body 43 having a portion 43A that extends beyond the locator block 28 and into the hole 29. In some embodiments, the portion 43A may threadably fit within the hole 29 with corresponding threads in each surface, as shown in FIG. 5B.

As will be described in greater detail below, the locator blocks 28 can be removed to allow for machining away of material from the lower surface 32 of the block 28 so as to reduce a width 28W of the lower portion 28B of the block 28. In this way, the second locator pin 48 can be brought closer to the side surface 26C1 of the wall 26C, and thus locate the wall 16C of the workpiece frame 16 at a different position further from the side surface 26C1 of the wall 26C of the tool base 26 than in a first position prior to machining of the block 28.

As can be seen in FIGS. 4B-5C, the locator block 28 includes an upper portion 28A and a lower portion 28B below the upper portion 28A. The upper portion 28A includes an upper surface 30 that faces the workpiece frame 16 when the block 28 is arranged on the tool base 26, and the lower portion 28B includes a lower surface 32 that also faces the workpiece frame 16 when the block 28 is arranged on the tool base 26. The upper and lower portions 28A, 28B define a back surface 34 opposite the upper and lower surfaces 30, 32 that is planar.

As can be seen in FIGS. 5A-5C, the upper portion 28A has a width 28X that is slightly smaller than the width 28W of the lower portion 28B such that the lower surface 32 is slightly offset from the upper surface 30 toward the tool base 26 when the block 28 is arranged on the tool base 26. In other words, the lower surface 32 defines a first plane and the upper surface 30 defines a second plane, the first plane being offset from the second plane a first distance toward the tool base 26 when the block 28 is arranged on the tool base 26.

The locator block 28 further includes a hole 36 that extends from the back surface 34 and into a larger hole 38 that opens at the upper surface 30, the second locator pin 45 being arranged with in the holes 36, 38. Specifically, similar to the first locator pin 24, the second locator pin 45 includes a main portion 46 and a larger head portion 47 defining a head surface 48 (also referred to herein as a forward surface) configured to contact the head surface 25 of the first locator pin 24 when the block 28 is arranged on the tool base 26. The step 45S created by the transition of the head portion 47 to the main portion 46 rests on the step 38S created by the transition of the hole 38 to the smaller hole 36 so as to prevent inward movement of the pin 45 when pressed on by the first locator pin 24. Also similar to the first locator pin 24, the second locator pin 45 protrudes slightly from the upper surface 30.

As shown in FIG. 5B, when the locator block 28 is arranged on the tool base 26, the lower surface 32 contacts the side surface 26C1 of the wall 26C and the second locator pin 45 contacts the first locator pin 24 of the workpiece frame 16. In the configuration shown in FIG. 5B, which may be referred to herein as a first configuration of the locator block 28 in some embodiments, the first plane of the lower surface 32 is offset from the second plane of the upper surface 30 by a first distance such that the second plane is further from the wall 26C of the tool base 26 than the first plane. In this configuration, the second locator pin 45 contacts the first locator pin 24 so as to locate the workpiece frame 16 on the tool base 26 in a first desired position. In some scenarios, this first desired position may be one in which the side surface 26C1 of the wall 26C is perfectly aligned with and coplanar with the side surface 16C1 of the arm 16C of the workpiece frame 16, as shown in FIG. 5B. In other embodiments, the first desired position may be a position in which the side surface 26C1 of the wall 26C is not perfectly aligned with and coplanar with the side surface 16C1 of the arm 16C of the workpiece frame 16.

As shown in FIG. 5C, the locator block 28 can be modified such that the block 28 locates the workpiece frame 16 slightly inwardly relative to the tool base 26 (i.e. the left direction along the movement axis 92). Specifically, FIG. 5C shows the first locator block 28 in a second configuration after having been modified in which the second plane of the upper surface 30 is offset from the first plane of the lower surface 32 a second distance that is less than the first distance. Modifying the locator block 28 is accomplished by reducing the width 28W of the lower portion 28B such that the head surface 48 of the second locator pin 45 is located closer toward the wall 26C of the tool base 26 when the block 28 is arranged on the tool base 26, which thus locates the workpiece frame 16 further to the left in FIG. 5C.

In order to reduce the width 28W of the lower portion 28B, the lower surface 32 of the locator block 28 is machinable by external means such that material can be removed from the lower surface 32 and thus reduce the width of the lower portion 28B of the block 28. The lower surface 32 may be machined by any method or means known in the art, such as, by way of non-limiting example, end mills, face mills, grinding machines, cutters, and the like. In some embodiments, the lower surface 32 includes a planar surface both before and after machining so that it lies flush against the side surface 26C1 of the wall 26C.

In some embodiments, the locator block 28 could be comprised of a material appropriate for the particular application of the workpiece 16 and tool base 26, namely which machines it will be utilized in. The material may be any suitable material that will function within and not be compromised by the machine in which the locator block 28 is be used. For example, in PECM applications, the material of the locator block 28 could be a corrosion resistant material with a relatively high hardness. For example, this may include 17-4 PH stainless steel, or in other embodiments, 300 series stainless steel. In some embodiments, the locator block 28 may be comprised of carbide, ceramic, or similar materials.

By way of the lower surface 32 being machinable, the locator block 28 can be selectively modifiable between multiple configurations. For example, the locator block 28 may be in an initial configuration prior to machining of the lower surface 32 (i.e. the first configuration) in which the width 28W of the lower portion 28B is the width shown in FIGS. 5A and 5B. Then, after the lower surface 32 is machined away such that the width 28W of the lower portion 28B is the width shown in FIG. 5C which is less than the width of FIGS. 5A and 5B, the locator block 28 is in the second configuration. When the locator block 28 is machined to be in the second configuration and is then recoupled to the tool base 26, the locator block 28 locates the workpiece frame 16 at a second desired position (i.e. slightly to the left along the movement axis 92 as shown in FIG. 5C).

The locator block 28 is not limited to two configurations, as the lower surface 32 can be further machined beyond the amount shown in FIG. 5C, or can be machined less than the amount shown in FIG. 5C. In some embodiments, material could be added onto the lower surface 32 so as to increase the width 28W of the lower portion 28B of the block 28 and thus locate the workpiece 16 such that the side surface 16C1 of the arm 16C is offset from the side surface 26C1 of the wall 26C in the opposite direction (i.e. to the right along the movement axis 92 as shown in FIG. 5C).

Referring again to FIG. 3, it can be seen that modifications of multiple locator blocks 28 can affect the position of the workpiece frame 16 on the tool base 26 in multiple directions. For example, if the locator block 28 arranged on the first wall 26A is modified similarly to the locator block 28 shown in FIG. 5C, the location of the workpiece frame 16 on the tool base 26 can be shifted slightly to the right (i.e. to the right along the movement axis 90 as shown in FIG. 3). Alternatively, a locator block 28 having been modified similar to the block 28 shown in FIG. 5C could be added to the second wall 26B in order to relocate the workpiece frame 16 on the tool base 26 slightly to the left (i.e. to the left along the movement axis 90 as shown in FIG. 3). In some embodiments in which two locator blocks 28 are arranged on a single wall (i.e. the two blocks 28 on the third wall 26C as shown in FIG. 3), the lower surface 32 of one of the blocks 28 can be machined less than the lower surface 32 of the other block 28 such that the wall 16C of the workpiece frame 16 is slightly angled relative to the wall 26C of the tool base 26. Other similar adjustments can be made to fine tune the positioning and location of the workpiece frame 16 on the tool base 26.

In some embodiments, the machine tool system 10 includes additional machines beyond the machine 14. For example, the machine tool system 10 may include the machine 14 capable of PECM and a second machine (not shown) capable of another type of machining. The second machine includes a tool base, similar to or the same as the tool base 26, and a shaft. The second machine may use specific probing points on the substantially planar surfaces of the arms 16A, 16B, 16C as primary datums. For example, the second machine may use four specific probing points, although more or less probing points are contemplated. These can include, for example, both secondary and tertiary button locators located at various positions on the workpiece frame 16 and/or the tool base 26, and can also include the additional holes 23A, 27A.

The workpiece frame 16 is repositionable on the machine 14 and relocatable to the second machine. Thus, the workpiece 12 may be transferred to the second machine without requiring removal of the workpiece 12 from the workpiece frame 16. On the second machine, the workpiece frame 16 may be placed in different positions such that the workpiece 12 is positioned in different orientations or positions, and in some embodiments, the positioning being altered via the modification of the locator blocks 28.

The second machine may be used for hole drilling via laser, cutting via laser, milling of surfaces, and/or cutting via electrical discharge machining (EDM). The second machine may also be used for inspection of the workpiece 12, for example, via non-contact three-dimensional scanning via blue light. The shaft of the second machine may move, similar to the shaft 15, or may remain stationary. The second machine may be a single axis machine or a multi axis machine.

The machine tool system 10 may include any combination of machines. For example, the machine tool system 10 may include the machine 14, the second machine capable of hole drilling via laser, a third machine capable of milling, a fourth machine capable of inspection, etc.

Alternative means for positioning the workpiece frame 16 relative to the tool base 26 are contemplated by the present disclosure, in particular alternative first and second locator components. These alternative first and second locator components may be used in addition to or separately from the locator blocks 28 described above.

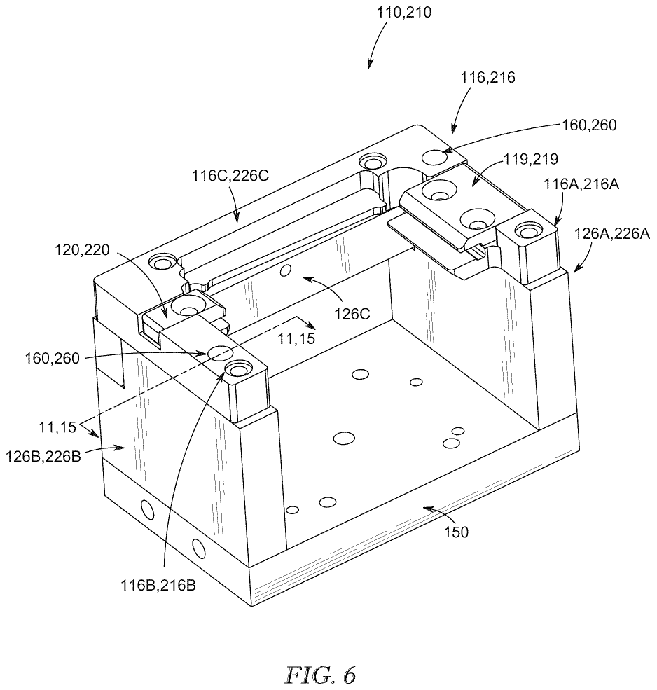

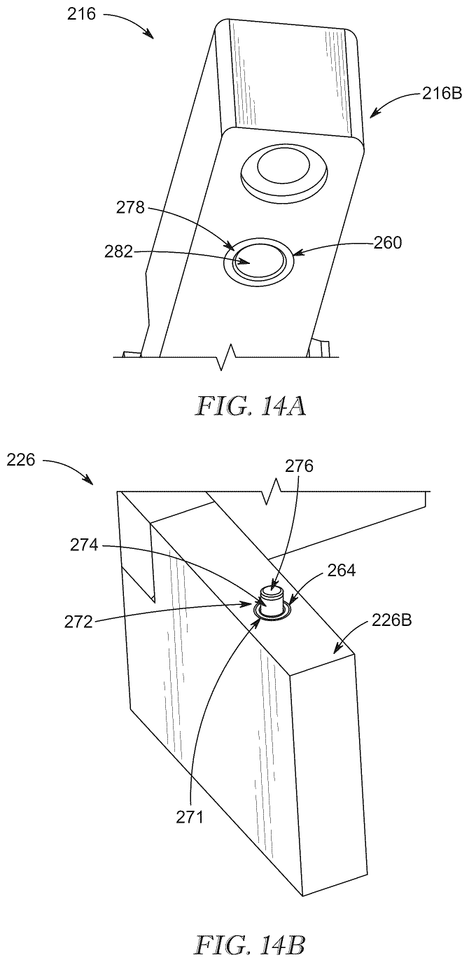

Additional embodiments of workpiece frames 116, 216 and tool bases 126, 226 being utilized in a machine tool system 110, 210 according to further aspects of the present disclosure are shown in FIGS. 6-15B. The workpiece frames 116, 216 and tool bases 126, 226 are similar to the workpiece frame 16 and tool base 26 shown in FIGS. 1-5C and described herein. Accordingly, similar reference numbers in the 100 and 200 series indicate features that are common between the workpiece frames 116, 216 and tool bases 126, 226 and the workpiece frame 16 and tool base 26. The description of the workpiece frame 16 and tool base 26 is incorporated by reference to apply to the workpiece frames 116, 216 and tool bases 126, 226, except in instances when it conflicts with the specific description and the drawings of the workpiece frames 116, 216 and tool bases 126, 226.

Similar to the workpiece frame 16 and tool base 26 described above, workpiece frames 116, 216 and tool bases 126, 226 include first and second locator components, in particular a first locator component arranged in the workpiece frame 116, 216 and a second locator component arranged in the tool base 126, 226.

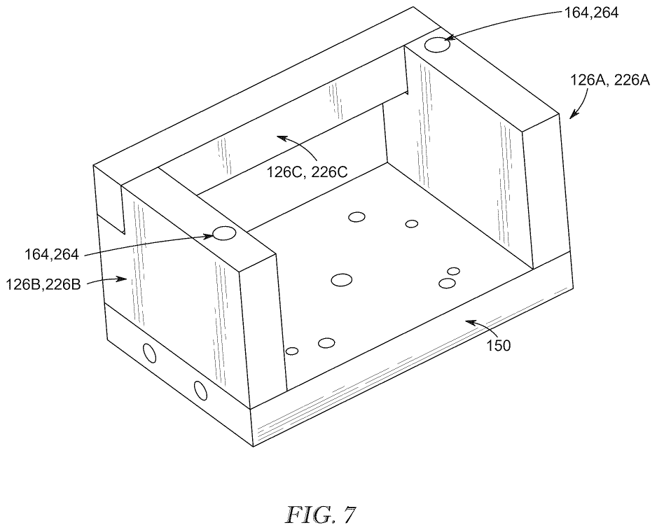

As can be seen in FIGS. 6 and 7, the workpiece frames 116, 216 and tool bases 126, 226 differ in that the frames 116, 216 include one or more holes 160, 260 extending from an upper surface to a lower surface of one or more of the arms (shown in arms 116A, 216A, 116B, 216B in the exemplary embodiments, but could be present in other arms 116C, 216C as well), and the tool bases 126, 226 include corresponding holes 164, 264 that extend from an upper surface of one or more of the walls that align with the hole 160, 260 when the workpiece frame 116, 216 is arranged on the tool base 126, 226 (hole 164, 264 shown in wall 126B, 226B in the exemplary embodiments, but could be present in other walls 126A, 226A, 126C, 226C or multiple walls). The first locator component 166, 266 is arranged in the hole 164, 264 formed in the wall 126B, 226B, and the second locator component 178, 278 is arranged in the hole 160, 260 formed in the arm 116B, 216B, and are configured to engage with each other to locate the workpiece frame 116, 216 on the tool base 126, 226 in a first desired position.

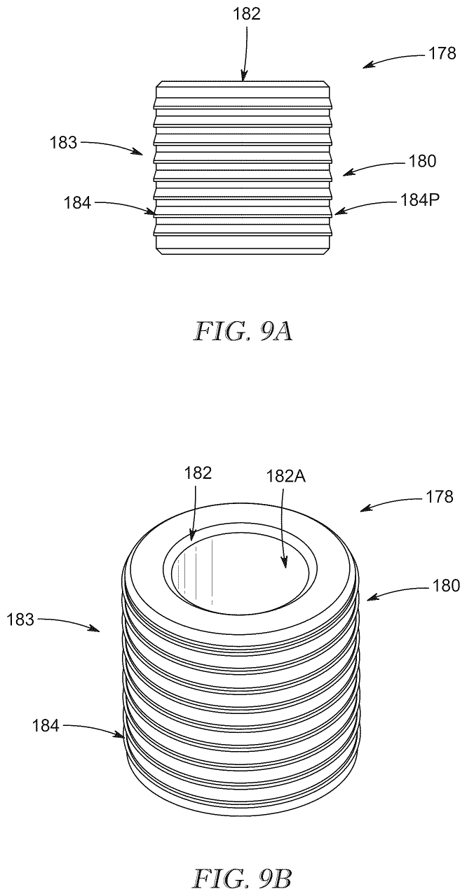

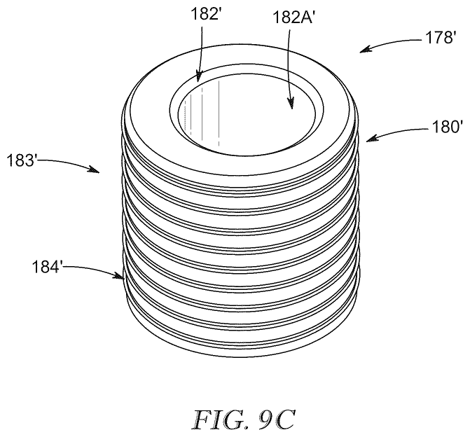

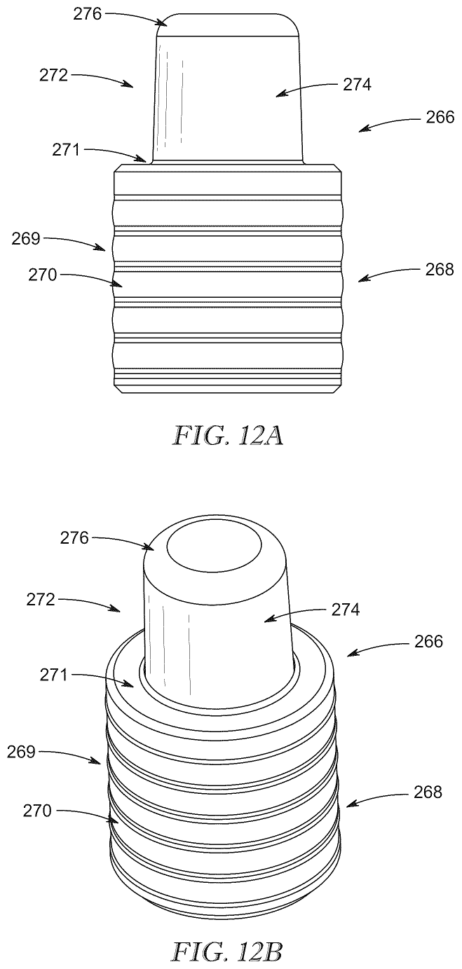

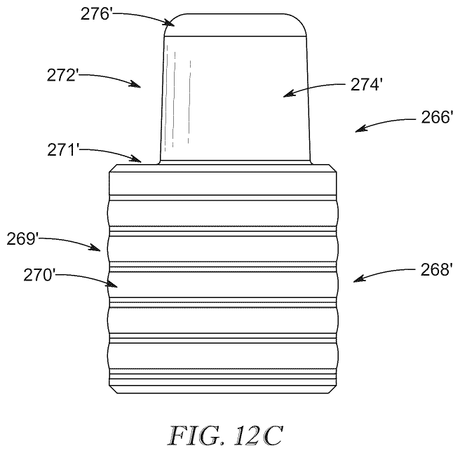

In some embodiments, first and second locator components 166′, 266′, 178′, 278′ (e.g. FIGS. 9C and 12C) (i.e. first and second locator components in a second configuration) can be formed that are different than the first and second locator components 166, 266, 178, 278 (i.e. first and second locator components in a first configuration) in order to locate the workpiece frame 116, 216 on the tool base 126, 226 in a second desired position different than the first desired position. In some embodiments, the first and second locator components 166, 266, 178, 278 can be machined or otherwise selectively modified prior to being inserted into the workpiece frame 116, 216 on the tool base 126, 226 in order to change the first and second locator components 166, 266, 178, 278 from the first configuration to the second configuration. In other embodiments, the system 110, 210 may include two different sets of first and second locator components 166, 266, 178, 278 that can be selectively inserted into the workpiece frame 116, 216 on the tool base 126, 226.

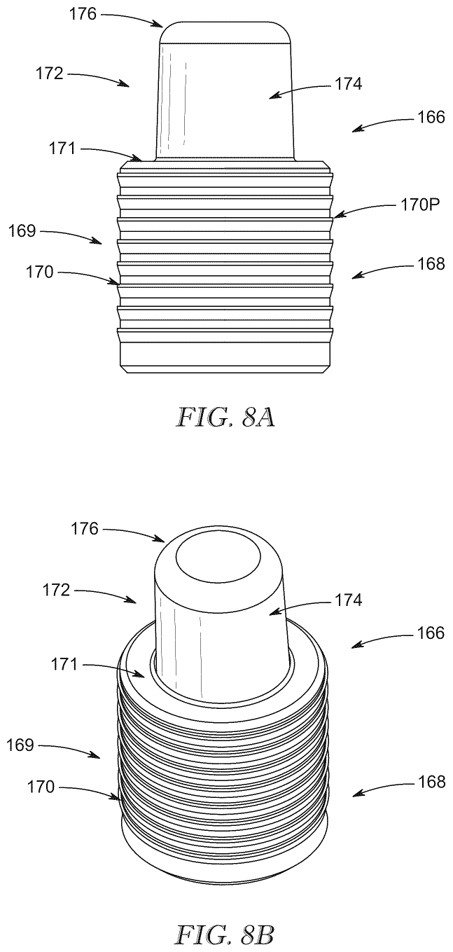

Illustratively, as shown in FIGS. 8A-11B, the first locator component 178 includes a locator sleeve 178 arranged in the hole 160 of the arm 116B of the workpiece frame 116. The locator sleeve 178 is shown in detail in FIGS. 9A and 9B. The second locator component 166 includes a locator pin 166 arranged in the hole 164 formed in the wall 126B of the tool base 126. The locator pin 166 is shown in detail in FIGS. 8A and 8B. The locator sleeve 178 receives the locator pin 166 therein when the workpiece frame 116 is arranged on the tool base 126 so as to locate the workpiece frame 116 relative to the tool base 126.

As shown in FIGS. 8A and 8B, the locator pin 166 includes a main body 168 and a pin head 172. The main body 168 may be formed to be cylindrical and include an outer circumferential surface 169 having a plurality of annular barbed protrusions 170 extending outwardly therefrom. The barbed protrusions 170 include a sloped outer surface with an annular sharp edge 170P formed on a top side of the protrusion 170. The main body 168 includes a top surface 171 having the pin head 172 extending upwardly therefrom. The pin head 172 has a smaller diameter than the main body 168 and may include a tapered portion 174 and a rounded chamfered tip 176.

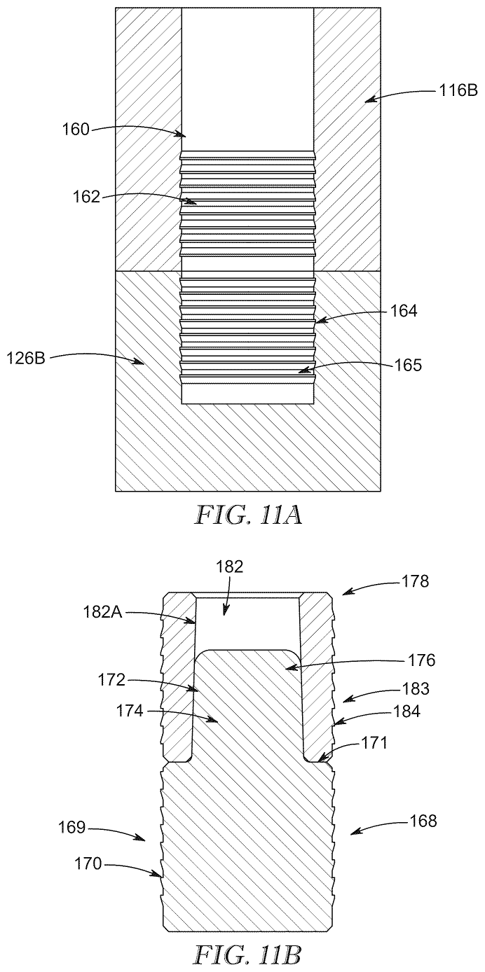

As shown in FIGS. 9A and 9B, the locator sleeve 178 is formed to receive the locator pin 166. The locator sleeve 178 is also formed to be cylindrical and has a main cylindrical body 180 with a central annular cavity 182 formed therethrough in an axial direction of the cylinder. The inner surface 182A of the cavity 182 is tapered to match the taper of the tapered portion 174 of the pin head 172 of the locator pin 166, as shown in FIG. 11B. The body 180 includes an outer circumferential surface 183 having a plurality of annular barbed protrusions 184 extending outwardly therefrom. The barbed protrusions 184 include a sloped outer surface with an annular sharp edge 184P formed on a bottom side of the protrusion 184.

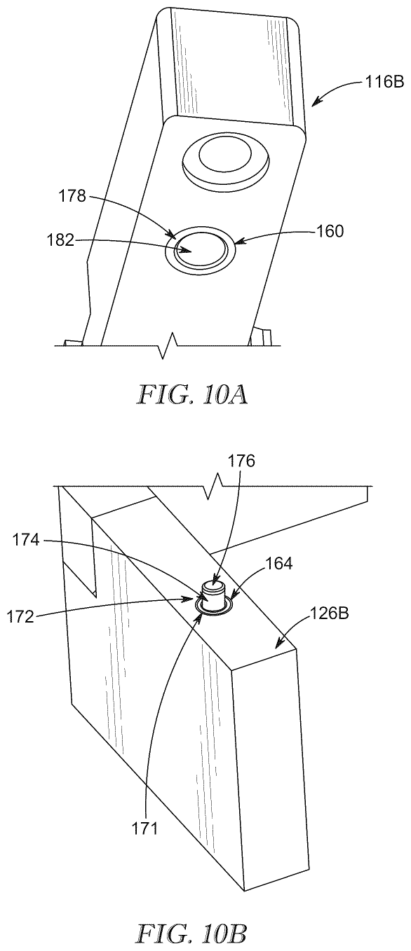

As can be seen in FIGS. 10A-11B, the locator pin 166, which is arranged in the hole 164 in the tool base 126, is configured to be arranged within the locator sleeve 178, which is arranged in the hole 160 in the workpiece frame 116, in order to locate the workpiece frame 116 on the tool base 126. In order to secure the locator sleeve 178 within the hole 160 in the arm 116B of the workpiece frame 116, the hole 160 is formed of a semi-deformable material such that, when the locator sleeve 178 is pressed into the hole 160, the inner surface of the hole 160, which may begin as substantially flat, may deform such that the inner surface of the hole 160 includes a plurality of annular barbed recesses 162 formed therein that match the barbed protrusions 184 of the locator sleeve 178, as shown in FIG. 11A. Similarly, in order to secure the locator pin 166 within the hole 164 in the wall 126B of the tool base 126, the hole 164 is formed of a semi-deformable material such that, when the locator pin 166 is pressed into the hole 164, the inner surface of the hole 164, which may begin as substantially flat, may deform such that the inner surface of the hole 164 includes a plurality of annular barbed recesses 165 formed therein that match the barbed protrusions 170 of the locator pin 166, as shown in FIG. 11A.

When the locator pin 166 is inserted and secured within the locator sleeve 178, the bottom side of the locator sleeve 178 contacts the upper surface 171 of the main body 168 of the locator pin 166. When inserted, the locator pin 166 mating with the locator sleeve 178 locates the workpiece frame 116 relative to the tool base 126.

By way of non-limiting example, instead of the first locator sleeve 178 being inserted in the workpiece frame 116, a different, second locator sleeve 178′ (i.e. a locator sleeve 178′ in the second configuration) can be inserted into the holes, as shown in FIG. 9C. The different, second locator sleeve 178 or the locator pin 166 can be created by modifying the first locator sleeve 178 or the locator pin 166 prior to insertion. For example, the locator sleeve 178′ includes a central annular cavity 182′ that is slightly offset from exact center along the central axis of the cylindrical main body 180′. This would cause the locator pin 166 to be slightly offset from center when inserted in the locator sleeve 178′, and thus the workpiece frame 116 to be slightly offset by the same amount relative to the tool base 126. Similar modifications could be made to the locator pin 166, or an entirely new locator pin 166 could be provided, to cause similar repositioning of the workpiece frame 116 on the tool base 126 (see FIG. 12C as an example, in which the pin head 272′ is slightly offset from exact center along the central axis of the cylindrical main body 268′).

An alternative configuration of the locator sleeve and the locator pin are shown in FIGS. 12A-15B. As can be seen in FIGS. 12A and 12B, the locator pin 266 includes a main body 268 and a pin head 272. The main body 268 may be formed to be cylindrical and include an outer circumferential surface 269 having a plurality of annular ribs 270 extending outwardly therefrom. The ribs 270 include a slightly curved or rounded surface, as can be seen in FIG. 12A. The main body 268 includes a top surface 271 having the pin head 272 extending upwardly therefrom. The pin head 272 has a smaller diameter than the main body 268 and may include a tapered portion 274 and a rounded chamfered tip 276.

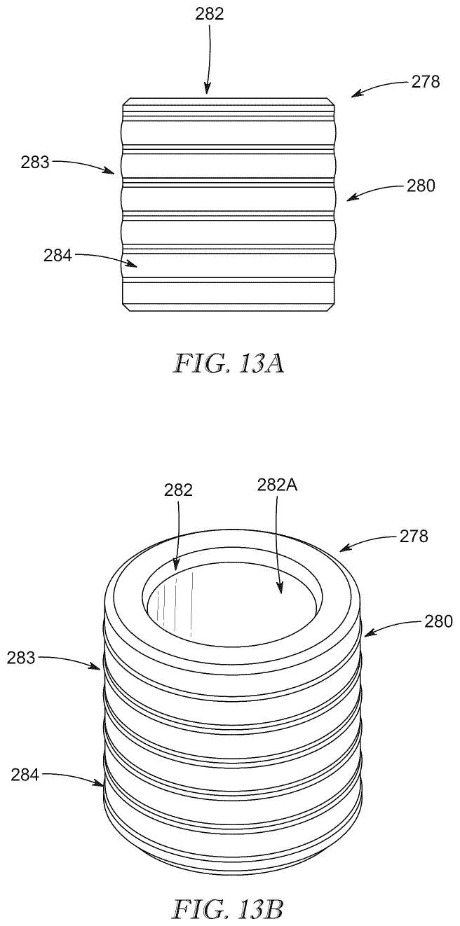

As shown in FIGS. 13A and 13B, the locator sleeve 278 is formed to receive the locator pin 266. The locator sleeve 278 is also formed to be cylindrical and has a main cylindrical body 280 with a central annular cavity 282 formed therethrough in an axial direction of the cylinder. The inner surface 282A of the cavity 282 is tapered to match the taper of the tapered portion 274 of the pin head 272 of the locator pin 266, as shown in FIG. 13B. The body 280 includes an outer circumferential surface 283 having a plurality of annular ribs 284 extending outwardly therefrom. The ribs 284 include a slightly curved or rounded surface, as can be seen in FIG. 13A.

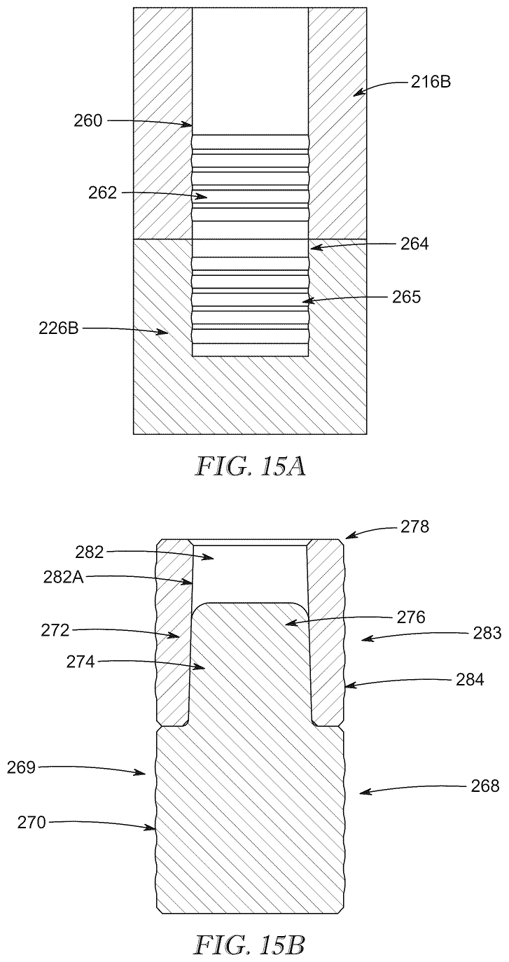

As can be seen in FIGS. 12A-13B, the locator pin 266, arranged in the hole 264 in the tool base 226, is configured to be arranged within the locator sleeve 278, arranged in the hole 260 in the workpiece frame 216, in order to locate the workpiece frame 216 on the tool base 226. In order to secure the locator sleeve 278 within the hole 260 in the arm 216B of the workpiece frame 216, the hole 260 is formed of a semi-deformable material such that, when the locator sleeve 278 is pressed into the hole 260, the inner surface of the hole 260, which may begin as substantially flat, may deform such that the inner surface of the hole 260 includes a plurality of annular recesses 262 formed therein that match the annular ribs 284 of the locator sleeve 278, as shown in FIG. 15A. Similarly, in order to secure the locator pin 266 within the hole 264 in the wall 226B of the tool base 226, the hole 264 is formed of a semi-deformable material such that, when the locator pin 266 is pressed into the hole 264, the inner surface of the hole 264, which may begin as substantially flat, may deform such that the inner surface of the hole 264 includes a plurality of annular recesses 265 formed therein that match the annular ribs 270 of the locator pin 266, as shown in FIG. 15A. Due to the large radius of curvature of the annular ribs 270, 284 on the locator pin 266 and the locator sleeve 278, the fit of the locator pin 266 and the locator sleeve 278 in the holes 260, 264 may be considered an interference fit.

When the locator pin 266 is inserted and secured within the locator sleeve 278, the bottom side of the locator sleeve 278 contacts the upper surface 271 of the main body 268 of the locator pin 266. When inserted, the locator pin 266 mating with the locator sleeve 278 locates the workpiece frame 216 relative to the tool base 226.

Similar to the locator sleeve 178 and the locator pin 166 of FIGS. 8A-11B, by way of non-limiting example, instead of the first locator sleeve 278 being inserted in the workpiece frame 216, a different, second the locator sleeve 278 or the locator pin 266 can be inserted into the holes. The different, second locator sleeve 278 or the locator pin 266 can be created by modifying the first locator sleeve 278 or the locator pin 266 prior to insertion by machining or other means, or an entirely new locator sleeve 278 or locator pin 266 could be produced and provided as part of the system 210. By way of non-limiting example, as shown in FIG. 12C, an additional or second locator pin 266′ (i.e. a locator pin 266′ in the second configuration) can include a pin head 272′ that is slightly offset from exact center along the central axis of the cylindrical main body 268′. This would cause the locator pin 266 to locate the locator sleeve 278′ slightly offset from center when inserted in the locator sleeve 278′, and thus the workpiece frame 216 to be slightly offset by the same amount relative to the tool base 226. Similar modifications could be made to the locator sleeve 266, or an entirely new locator pin 266 could be provided, to cause similar repositioning of the workpiece frame 216 on the tool base 226 (see FIG. 9C as an example, as described above).

In some embodiments, the locator pins 166, 266 and the locator sleeves 178, 278 could be comprised of a material appropriate for the particular application of the workpiece 116, 216 and tool base 126, 226, namely which machines they will be utilized in. The material may be any suitable material that will function within and not be compromised by the machine in which the locator pins 166, 266 and the locator sleeves 178, 278 are be used. For example, in PECM applications, the material of the locator pins 166, 266 and the locator sleeves 178, 278 could be carbide or other similar materials. Illustratively, after being formed, the locator pins 166, 266 and the locator sleeves 178, 278 are hard coated to avoid galling when pressed into the holes of the tool base 216, 226.

In some embodiments, a diamond-like carbon wear-resistant coating can be utilized to coat the locator pins 166, 266 and the locator sleeves 178, 278. In some embodiments, the coating of the locator pins 166, 266 and the locator sleeves 178, 278 can include titanium nitride, aluminum titanium nitride, an oxide coating, or the like. The coating can also be applied via vapor deposition, and can be made to be very thin. The coating may be applied to all outer surfaces of the locator pins 166, 266 and the locator sleeves 178, 278 so as to prevent sticking of the locator pins 166, 266 and the locator sleeves 178, 278 with each other, as well as within the holes of the tool base 216, 226 in the case they may need to be removed. As such, the outer circumferential surfaces 168, 268, the outer surfaces of the pin heads 172, 272, the outer circumferential surfaces 183, 283, and the inner surfaces 182A, 282A are coated.

Providing the first and second locator components described herein, in particular the first locator block 28, the locator pins 166, 266, and the locator sleeves 178, 278, enable easy setting of the positioning and locating of the workpiece frame 16, 116, 216 on the tool base 26, 126, 226 without requiring extensive modifications to the workpiece frame 16, 116, 216 and the tool base 26, 126, 226 themselves. These features also provide great flexibility in that the same workpiece frame 16, 116, 216 and the tool base 26, 126, 226 can be used with multiple workpieces 12 and/or machines 14. For example, different locator blocks can be produced for different workpieces and/or machines such that specific locator blocks can be utilized with specific workpieces and/or machines. Similarly, different locator sleeves and locator pins can be produced for different workpieces and/or machines such that specific locator sleeves and locator pins can be utilized with specific workpieces and/or machines. Many other possible usage scenarios in which flexibility and ease of using the same workpiece frame 16, 116, 216 and the tool base 26, 126, 226 by the modifiable and/or interchangeable first and second locator components are enabled by the present disclosure.

A method according to a further aspect of the present disclosure includes providing a machine 14 configured to modify a workpiece 12, the machine 14 including a tool base 26, providing a workpiece frame 16 that is repositionable on and couplable to the tool base 26 to support the workpiece 12, and arranging the workpiece 12 in the workpiece frame 16. The method can further include arranging the workpiece frame 16 on the tool base 26. The workpiece frame 16 includes a first locator component 24, 166, 266 and the tool base 26 includes a second locator component 28, 178, 278 arranged on the tool base 26 and configured to engage the first locator component 24, 166, 266 of the workpiece frame 16 when the workpiece frame 16 is arranged on the tool base 26 prior to coupling of the workpiece frame 16 to the tool base 26. The first and second locator components 24, 166, 266, 28, 178, 278 are configurable in a first configuration and a second configuration, wherein, in the first configuration, the engagement of the first and second locator components 24, 166, 266, 28, 178, 278 locates the workpiece frame 16 on the tool base 26 in a first desired position relative to the tool base 26 such that the workpiece frame 16 is configured to be coupled to the tool base 26 in the first desired position.

The method can further include determining a second desired position of the workpiece frame 16 relative to the tool base 26 different from the first desired position, removing at least one of the first and second locator components 24 from at least one of the workpiece frame 16 or the tool base 26, and coupling the removed at least one of the first and second locator components 24 to the at least one of the workpiece frame 16 and the tool base 26 in the second configuration of the at least one of the first and second locator components 24 such that the second locator component 28 engages the first locator component 24 so as to locate the workpiece frame 16 on the tool base 26 in a second desired position relative to the tool base 26 different than the first desired position.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A machine tool system comprising:
a thin-walled three-dimensional workpiece,
a machine configured to modify the thin-walled three-dimensional workpiece, the machine including a tool base configured to at least partially support the thin-walled three-dimensional workpiece and a shaft spaced apart from the tool base along a first axis and configured to move along the first axis relative to the tool base to modify the thin-walled three-dimensional workpiece, and
a workpiece frame that is repositionable on and couplable to the tool base to support the thin-walled three-dimensional workpiece relative to the first axis during modification of the thin-walled three-dimensional workpiece, the tool base including a first wall configured to support at least a portion of the workpiece frame, the workpiece frame including a first arm configured to be generally aligned with the first wall of the tool base when the workpiece frame is coupled to tool base,
wherein the workpiece frame includes a first locator component arranged on the first arm and the tool base includes a second locator component arranged on the first wall and configured to engage the first locator component of the workpiece frame when the workpiece frame is arranged on the tool base prior to coupling of the workpiece frame to the tool base, and wherein the engagement of the first and second locator components locates the workpiece frame on the tool base in a first desired position relative to the tool base such that the workpiece frame is configured to be coupled to the tool base in the first desired position.

2. The machine tool system of claim 1, wherein the first wall of the tool base includes a side surface that faces a first direction, and wherein the second locator component includes a first locator block removably coupled to the side surface of the tool base, the first locator block being configured to engage the first locator component of the workpiece frame when the workpiece frame is arranged on the tool base.

3. The machine tool system of claim 2, wherein the first arm of workpiece frame includes a side surface facing the first direction, the first locator component being arranged on the side surface, wherein the first locator block includes a lower portion removably coupled to the side surface of the tool base and an upper portion above the lower portion, and wherein the upper portion includes a first locator pin that engages the first locator component when the workpiece frame is arranged on the tool base so as to locate the workpiece frame relative to the tool base.

4. The machine tool system of claim 3, wherein the lower portion of the first locator block includes a lower surface that contacts the side surface of the first wall of the tool base when the first locator block is removably coupled to the first wall, the lower surface defining a first plane, wherein the upper portion of the first locator block includes an upper surface defining a second plane, wherein the upper portion includes an upper hole formed therein within which the first locator pin is arranged, wherein the first locator component is a second locator pin arranged in a hole in the first arm of the workpiece frame, and wherein a forward surface of the first locator pin contacts and engages the second locator pin when the workpiece frame is arranged on the tool base so as to locate the workpiece frame relative to the tool base.

5. The machine tool system of claim 4, wherein, in a first configuration of the first locator block, the second plane defined by the upper surface of the first locator block is offset from the first plane defined by the lower surface a first distance in the first direction such that the second plane is further from the first wall of the tool base than the first plane when the first locator block is removably coupled to the first wall, and wherein, in a second configuration of the first locator block, the second plane is offset from the first plane a second distance in the first direction less than the first distance.

6. The machine tool system of claim 5, wherein the lower surface of the first locator block is machinable such that material can be removed from the lower surface such that, prior to machining the lower surface, the first locator block is in the first configuration, and, after machining the lower surface to remove material therefrom, the first locator block is in the second configuration.

7. The machine tool system of claim 6, wherein, in the first configuration, the first locator pin of the first locator block contacts the second locator pin of the workpiece frame so as to locate the workpiece frame in the first desired position relative to the tool base, and wherein, in the second configuration, the first locator pin of the first locator block contacts the second locator pin of the workpiece frame so as to locate the workpiece frame in a second desired position relative to the tool base different than the first desired position.

8. The machine tool system of claim 6, wherein the workpiece frame includes a second arm extending from a terminal end of the first arm, wherein the tool base includes a second wall extending from a terminal end of the first wall, and wherein a second locator block is removable coupled to the second wall and configured to engage a third locator component of the workpiece frame when the workpiece frame is arranged on the tool base.

9. The machine tool system of claim 1, wherein the first locator component includes a first locator sleeve arranged on the first arm of the workpiece frame and the second locator component includes a first locator pin arranged on the first wall of the tool base, and wherein the first locator sleeve receives the first locator pin therein when the workpiece frame is arranged on the tool base so as to locate the workpiece frame relative to the tool base in a first desired position.

10. The machine tool system of claim 9, wherein the first arm of the workpiece frame includes a first hole formed therein that opens toward the first wall of the tool base when the workpiece frame is arranged on the tool base, wherein the first wall includes a second hole formed therein that opens toward the first hole when the workpiece frame is arranged on the tool base, and wherein the first locator sleeve is arranged in the first hole and the first locator pin is arranged in the second hole and protrudes therefrom.

11. The machine tool system of claim 10, further comprising
a second locator sleeve shaped differently than the first locator sleeve, and
a second locator pin shaped differently than the first locator pin,
wherein the second locator sleeve and pin can be inserted into the first and second holes instead of the first locator sleeve and pin so as to locate the workpiece frame relative to the tool base in a second desired position different than the first desired position.

12. The machine tool system of claim 11, wherein the first and second holes each include a plurality of annular barbed recesses formed therein, wherein the first locator sleeve and the first locator pin each include a plurality of annular barbed protrusions extending from outer surfaces of the first locator sleeve and the first locator pin, and wherein the plurality of annular barbed protrusions fit within the plurality of annular barbed recesses of the first and second holes so as to secure the first locator sleeve and the first locator pin within the first and second holes.

13. The machine tool system of claim 11, wherein the first and second holes each include a plurality of annular recesses formed therein, wherein the first locator sleeve and the first locator pin each include a plurality of annular ribs extending from outer surfaces of the first locator sleeve and the first locator pin, and wherein the plurality of annular ribs fit within the plurality of annular recesses of the first and second holes so as to secure the first locator sleeve and the first locator pin within the first and second holes.

14. A machine tool system comprising:
a workpiece,
a machine configured to modify the workpiece, the machine including a tool base configured to at least partially support the workpiece, and
a workpiece frame that is repositionable on and couplable to the tool base to support the workpiece,
wherein the workpiece frame includes a first locator component and the tool base includes a second locator component arranged on the tool base and configured to engage the first locator component of the workpiece frame when the workpiece frame is arranged on the tool base prior to coupling of the workpiece frame to the tool base, wherein the first and second locator components are configurable in a first configuration and a second configuration, wherein, in the first configuration, the engagement of the first and second locator components locates the workpiece frame on the tool base in a first desired position relative to the tool base such that the workpiece frame is configured to be coupled to the tool base in the first desired position, and wherein, in the second configuration, the second locator component engages the first locator component so as to locate the workpiece frame on the tool base in a second desired position relative to the tool base different than the first desired position.

15. The machine tool system of claim 14, wherein the tool base includes a side surface, and wherein the second locator component includes a first locator block removably coupled to the side surface of the tool base, the first locator block being configured to engage the first locator component of the workpiece frame when the workpiece frame is arranged on the tool base, wherein the workpiece frame includes a side surface, the first locator component being arranged on the side surface, wherein the first locator block includes a lower portion removably coupled to the side surface of the tool base and an upper portion above the lower portion, and wherein the upper portion includes a first locator pin that engages the first locator component when the workpiece frame is arranged on the tool base so as to locate the workpiece frame relative to the tool base.

16. The machine tool system of claim 15, wherein the lower portion of the first locator block includes a lower surface that contacts the side surface the tool base when the first locator block is removably coupled to the side surface of the tool base, the lower surface defining a first plane, wherein the upper portion of the first locator block includes an upper surface defining a second plane, wherein, in the first configuration, the second plane defined by the upper surface of the first locator block is offset from the first plane defined by the lower surface a first distance in the first direction such that the second plane is further from the tool base than the first plane when the first locator block is removably coupled to the tool base, wherein, in the second configuration, the second plane is offset from the first plane a second distance in the first direction less than the first distance, and wherein the lower surface of the first locator block is machinable such that material can be removed from the lower surface such that, prior to machining the lower surface, the first locator block and the first locator component are in the first configuration, and, after machining the lower surface to remove material therefrom, the first locator block and the first locator component are in the second configuration.

17. The machine tool system of claim 15, wherein the first locator component includes a first locator sleeve arranged on a first arm of the workpiece frame and the second locator component includes a first locator pin arranged on a first wall of the tool base, wherein, in the first configuration of the first locator component and the second locator component, the first locator sleeve receives the first locator pin therein when the workpiece frame is arranged on the tool base so as to locate the workpiece frame relative to the tool base in the first desired position, wherein the machine tool system further includes a second locator sleeve shaped differently than the first locator sleeve and a second locator pin shaped differently than the first locator pin, wherein the second locator sleeve corresponds to the second configuration of the first locator component and the second locator pin corresponds to the second configuration of the second locator component, and wherein, in the second configuration of the first locator component and the second locator component, the second locator sleeve and pin are arranged on the workpiece frame and the tool base instead of the first locator sleeve and pin such that the second locator sleeve receives the second locator pin therein when the workpiece frame is arranged on the tool base so as to locate the workpiece frame relative to the tool base in the second desired position.

18. A method comprises
providing a machine configured to modify a workpiece, the machine including a tool base,
providing a workpiece frame that is repositionable on and couplable to the tool base to support the workpiece,
arranging the workpiece in the workpiece frame,
arranging the workpiece frame on the tool base, wherein the workpiece frame includes a first locator component and the tool base includes a second locator component removably arranged on the tool base and configured to engage the first locator component of the workpiece frame when the workpiece frame is arranged on the tool base prior to coupling of the workpiece frame to the tool base, wherein the first and second locator components are configurable in a first configuration and a second configuration, wherein, in the first configuration, the engagement of the first and second locator components locates the workpiece frame on the tool base in a first desired position relative to the tool base such that the workpiece frame is configured to be coupled to the tool base in the first desired position,
determining a second desired position of the workpiece frame relative to the tool base different from the first desired position,
removing at least one of the first and second locator components from at least one of the workpiece frame or the tool base, and
coupling the removed at least one of the first and second locator components to the at least one of the workpiece frame and the tool base in the second configuration of the at least one of the first and second locator components such that the second locator component engages the first locator component so as to locate the workpiece frame on the tool base in a second desired position relative to the tool base different than the first desired position.

19. The method of claim 18, wherein the tool base includes a first wall having a side surface that faces a first direction, wherein the workpiece frame includes a first arm having a side surface that faces the first direction, wherein the second locator component includes a first locator block removably coupled to the side surface of the tool base, the first locator block being configured to engage the first locator component of the workpiece frame when the workpiece frame is arranged on the tool base, and wherein the first locator block includes an upper surface having a first locator pin configured to engage the first locator component of the workpiece frame and a lower surface that is machinable such that material can be removed from the lower surface such that, prior to machining the lower surface, the first locator block and the first locator component are in the first configuration, and, after machining the lower surface to remove material therefrom, the first locator block and the first locator component are in the second configuration.

20. The method of claim 19, wherein the arranging of the workpiece frame on the tool base causes the first locator pin of the first locator block to contact the first locator component of the workpiece frame such that the side surface of the first arm of the workpiece frame is generally aligned with the side surface of the first wall of the tool base, and wherein the coupling of the removed at least one of the first and second locator components includes coupling the first locator block to the side surface of the first wall of the tool base in the second configuration so as to cause the first locator block to contact the first locator component of the workpiece frame such that the side surface of the first arm of the workpiece frame is offset from the side surface of the first wall of the tool base in a direction away from the first locator block.
